(19) United States
(12) Patent Application Publication
(10) Pub. No.: US 2025/0211527 A1
(43) Pub. Date: Jun. 26, 2025

(54) PACKET LOSS PREVENTION DURING CONTROL PLANE UPDATES

(71) Applicant: Arista Networks, Inc., Santa Clara, CA (US)

(72) Inventor: Lakshmikantha Chowdary Pothula, Santa Clara, CA (US)

(73) Assignee: Arista Networks, Inc., Santa Clara, CA (US)

(21) Appl. No.: 18/394,858

(22) Filed: Dec. 22, 2023

(51) Int. Cl. H04L 45/745

(52) U.S. Cl. CPC H04L 45/745

(57) ABSTRACT

A networking device has a control plane that manages a data plane having a forwarding table with entries describing the operation of the data plane. When the control plane applies a modification, such as a software update, the control plane may re-determine table entries for the forwarding table. Rather than automatically pausing processing of the data plane while the table entries are redetermined and applied to the forwarding plane, the control plane copies the forwarding table to a shadow table and uses the shadow table to initially process entries after the control plane is modified. Entries are matched with the shadow table to determine whether the modified control plane actually requires modification to the existing data plane, enabling selective pausing of the data plane.

### BACKGROUND

This disclosure relates generally to networking device updates and reducing network device processing downtime due to control plane updates.

Networking devices are often configured with a data plane and a control plane. The data plane receives packets from ingress interfaces and processes the packets for transmission to a subsequent device on a network via a respective egress interface of the networking device. Components of the data plane are often implemented in hardware to maximize processing throughput. The control plane configures various tables and other properties for operation of the data plane in communication with other networking devices, installing routing, packet processing, and similar data to the data plane.

When the control plane is updated or otherwise modified, such as with a software update, operation of the control plane is typically paused while the modification is applied, such that the control plane does not apply updates to the data plane during the update. To prevent improper operation of the data plane, operation of the data plane is typically also paused during the update until the control plane can determine and install correct configurations for the data plane after the update. This can cause network interruptions as a result of the update process as the networking device pauses its processing.

### BRIEF DESCRIPTION OF THE DRAWINGS

FIG. 1 shows example components of a networking device, according to one embodiment.

FIG. 2 shows example interactions between a forwarding table of the data plane, an update manager, and feature agents, according to one embodiment.

FIG. 3 is an example process for selectively updating a forwarding table after a modification to a networking controller, according to one embodiment.

FIGS. 4A-C show example processing of regenerated entries with respect to a shadow table, according to various embodiments.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Overview

To reduce interruptions due to updates in the control plane and prevent unnecessary interruption, the data plane continues to process packets during the update. After the update, an update manager retrieves a copy of the current tables (together a “forwarding table”) used by the data plane as a “shadow” table for comparison to the post-modification table configuration as generated by the control plane. In many cases, the previous configuration of the forwarding plane differs from the post-modification entries of the updated control plane (although they may also be the same), such that the entries for the forwarding table may be re-determined with the modified control plane to ensure the data plane contains optimal parameters and has the post-modification entries according to the modified control plane behavior. Various agents of the control plane may re-generate or otherwise update information for post-modification entries in the data plane's forwarding table. The agents may then send information about these “regenerated entries” to be written to the forwarding table to the update manager.

However, in many cases, the post-modification entries for the forwarding table (as reflected by the regenerated entries) may effectively represent the same configuration as the previous configuration before the control plane modification, such that there is ultimately no state change in the forwarding table. Rather than automatically pause the data plane for replacement of the forwarding table in the data plane with the regenerated entries (which now reflect the “desired” state of the forwarding table after the control plane modification), the update manager receives regenerated entries and determines whether the regenerated entries are already reflected in the data plane by finding matching entries in the shadow table and comparing the matching entries with the regenerated entries. The matching entries in the shadow table may be determined based on a key lookup or content hash depending on the type of table and entry. To determine a match for entries normally retrieved with an index (which may be unknown to the updated control plane), the contents of the indexed entries may be hashed to generate a hash map that may be matched with corresponding information of regenerated entries.

When a regenerated entry matches an entry in the shadow table, the contents of the respective entries are compared to determine whether the regenerated entry modifies the contents of the shadow table. When no entries in the shadow table are changed by the regenerated entries, no modifications are made to the data plane due to the update and the data plane continues to operate without interruption in packet processing. When there is a modification relative to the shadow table, the entry in the shadow table is flagged for revision in the date plane, rather than immediately writing the revision, such that all modifications may be collected and written together after all of the regenerated entries are evaluated (e.g., for a particular type of table). For entries in the shadow table that did not correspond to any regenerated entries, in some embodiments, these entries in the shadow table indicate stale entries that are pruned from the data plane. As such, the forwarding plane may continue to process packets according to the prior configuration (from before the modification to the control plane) while the regenerated entries are processed. In some embodiments, all regenerated entries are processed to identify and consolidate any modifications of the shadow table for application to the data plane together. In this instance, the data plane may operate with its prior configuration while modifications to the shadow table are consolidated for application to the forwarding table in the data plane as a group. In other embodiments, the data plane is paused when a regenerated entry is identified that differs from the shadow table, indicating the currently-used forwarding table includes at least one out-of-date entry. In some embodiments, when a regenerated entry is identified that would modify the forwarding table, packet processing is paused only for the affected table (e.g., a particular type of table), entries, or portion of the forwarding table.

### Example Networking Device

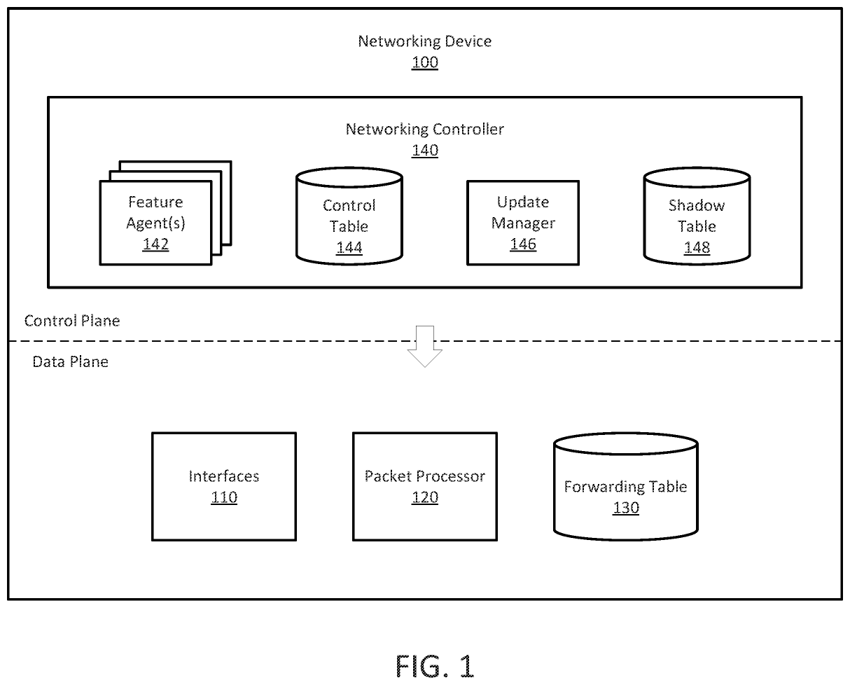

FIG. 1 shows example components of a networking device 100, according to one embodiment. The various components shown in FIG. 1 are generally discussed with respect to their functional behavior, such that various implementations may separate the discussed functionality into additional components, or further combine the functionality to fewer components than discussed herein. In addition, in many instances, the discussed components are implemented in hardware circuits, registers, memories, processing circuits, and so forth, and thus may include application-specific circuits, programmable circuits, as well as general-purpose processors (that operate on instructions in a memory, such as a non-transitory computer-readable medium) for performing the discussed functions.

Networking devices, such as networking device 100, receive and transfer information (e.g., as packets) in a network to reach a destination, according to one embodiment. The networking device 100 and related processes discussed herein may also be applied to different networking configurations and architectures. For example, the networking architecture may include communication across disparate datacenters, spine-and-leaf architectures (e.g., within a datacenter), communication across the Internet, and other types of configurations. In general, the networking device 100 provides various network switching and routing services between various computing devices and may provide networking services with L2 and/or L3 network addressing (e.g., including handling with Media Access Control (MAC) and Internet Protocol (IP) addresses). The networking device 100 may also be configured with virtual local area networking (VLAN), label-based processing (e.g., with multi-protocol label switching (MPLS) and additional services.

The different networking devices 100 may transmit packets that include a payload for delivery and header information describing various information for handling processing of the packet during network communication. The headers may include various types of information, including information, for example, about the type of data, source, destination, sequence information, priority information, virtual private network (VPN) membership, labels, and so forth. The networking devices use the headers to determine the handling of each packet, and in the process may add, modify, remove, and otherwise change the set of headers for a packet.

The networking device 100 may apply different types of approaches for forwarding a packet towards its final destination. The particular processing by a particular networking device 100 may vary in different embodiments and in different configurations, and may include determining routes in conjunction with other networking devices, including broadcasting information about intended destinations and configuring routes in conjunction with other devices.

The networking device 100 includes a number of interfaces 110 for receiving and sending packets. Packets received at an interface 110 may be stored during processing at a packet buffer (not shown) and processed by a packet processor 120 for processing and routing determinations with subsequent egress of the packet at one of the interfaces 110, which is typically a different interface 110 than the interface 110 at which the packet was received. In some embodiments, received packets may also be filtered at the interface 110 or by another component (such as a packet processor 120), for example, to retain packets that are addressed to the networking device 100, and discard packets that are not addressed to the networking device 100. This filtering may be based, for example, on hardware-level addresses (i.e., link layer addresses), such as a Media Access Control (MAC) address associated with the networking device 100 or its interfaces 110.

The packet processor 120 processes received packets according to information in a forwarding table 130. The forwarding table 130 may be instantiated as one or more memories, registers, or tables holding the relevant information for determining one or more forwarding parameters describing how the packet processor 120 will handle the packet. Such forwarding parameters may include specifying one of the interfaces 110 for egress of the packet along with information for modifying the packet before egressing the packet. As a simple example, the forwarding parameters for a particular packet may specify a particular interface 110 for egress along with a destination MAC address for the nexthop device (i.e., the immediately subsequent device) to modify the respective MAC address in the packet header.

The forwarding table 130 is thus used herein to generally describe the information that may be applied by the packet processor 120 in determining the forwarding parameters for handling a packet. The forwarding table 130 includes various types of information according to particular types of packets and/or packet headers received by the networking device 100. For example, the forwarding table 130 may include one table for determining a nexthop device based on a lookup of an entry with a destination network address (e.g., an Internet Protocol (IP) address) of the packet. That table may return a pointer, reference, or other index for one or more other tables in which a particular egress interface and a destination MAC address for the nexthop device are stored. As such, the various entries in the forwarding table 130 may be accessed with different types of information, may reference one another, and may differ according to the particular type of handling configured for the networking device 100.

Together, the packet processor 120 and forwarding table 130 may be considered a “data plane” for processing packets by the networking devices. The respective components for the packet processor 120 and forwarding table 130 are often instantiated in hardware, such as application-specific integrated circuits (ASICs) and other high-speed components to maximize throughput of the packets through the data plane.

A networking controller 140 controls execution of the data plane and is generally responsible for modifying parameters or other configurations for the packet processor 120 and populating information in the forwarding table 130. The networking controller 140 may gather information about available devices (locally or remotely), broadcast and receive information about devices, routes, and other information for configuring the data plane. In some embodiments, the networking controller 140 communicates with respective components of other networking devices to effectively learn network topology, generate routes, configure authorizations and quality of service information, and implement other types of data control.

The networking controller 140 is typically a processor with associated memories (e.g., non-volatile memory storing instructions for the networking controller). The networking controller may implement an operating system for performing its functions. The networking controller 140 includes various software modules such as a set of feature agents 142 and an update manager 146 for performing its functions.

The feature agents 142 implement the various networking control features of the networking controller 140 to generate entries for the forwarding table used in operation of the data plane. The feature agents 142 may be considered separate components or “agents” operating in the networking controller 140 and relate to different types of control or other features of the networking controller 140. One feature agent 142 may manage routing processes, another may manage VLAN authentication and coordination, another may manage quality of service configurations, and so forth. The feature agents 142 store data relating to its operations in a control table 144. The control table 144 may include similar data to the forwarding table 130, along with additional metadata and other information for coordinating configuration of the forwarding table 130.

The update manager 146 manages changes to the data plane when a modification to the networking controller 140 is implemented. The networking controller 140 may occasionally be modified (e.g., a software update or other configuration change of the networking controller 140) in a way that may change the operation of the feature agents 142. When the networking controller 140 is modified, the configuration of the data plane (e.g., operation of the packet processor 120 and state of the forwarding table 130) may be static during the modification, enabling continued packet processing by the networking device 100. After the modification is applied, the control table 144 may be cleared or out of date (either relative to control signals that occurred during the modification or changed operation of the feature agents 142) and the feature agents 142 recalculate the control table 144 and related entries for the forwarding table 130.

The update manager 146 coordinates application of the entries for the forwarding table 130 after a modification to the networking controller 140. In many cases, the recalculated configuration of the forwarding table 130, after the modification of the networking controller 140, may be similar or identical to the previous configuration before the modification. As the state of the forwarding table 130 was specified by the networking controller 140 before the modification, it may already contain the configuration effective for continued operation, and when it can be determined to have identical values, can continue operation after the modification with no interruption. To enable continued operation and minimize interruption to packet processing, the update manager 146 copies the state of the forwarding table 130 to a shadow table 148 and determines the differences of the entries for the forwarding table 130 with reference to the shadow table 148. Though shown here as a single table, the shadow table 148 may represent multiple individual data tables that may be stored and/or accessed in different ways in the data plane (e.g., accessed by key, index, TCAM, etc.)

The data plane may continue to operate with the forwarding table 130 while the update manager 146 processes requests from the feature agents 142. The update manager 146 may consolidate any changes to the forwarding table 130 for application together. The update manager 146 may also determine whether and when to pause processing of the data plane, for example by continuing processing and pausing data processing when consolidated changes are ready to be applied or without pausing when the post-modification entries do not yield any data plane change. In additional embodiments, the data plane may be paused when the update manager 146 identifies a change to be made to the forwarding table 130. The update manager 146 may thus selectively pause operation of the data plane (e.g., packet processor 120) when changes are determined with respect to the prior state of the forwarding table 130.

### Control Plane Modifications and Selective Processing Pause

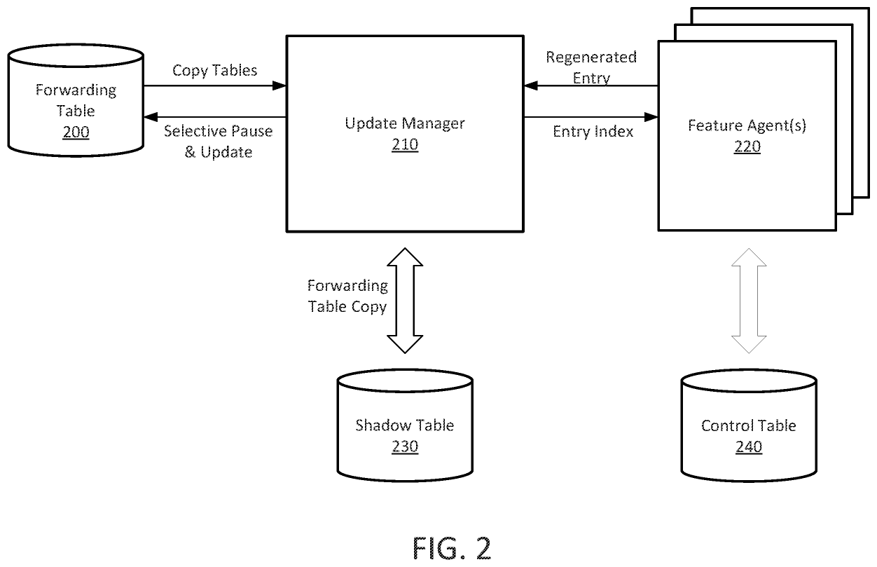

FIG. 2 shows example interactions between a forwarding table 200 of the data plane, an update manager 210, and feature agents 220, according to one embodiment. When a modification is applied to the networking controller, the forwarding table 200 may continue to be used to process packets according to its current configuration. After the modification is applied and the networking controller executes normally, the update manager 210 accesses the forwarding table 200 and copies its data tables to a shadow table 230. The copied data may include the contents of the data along with the memory locations (i.e., an index) at which the data is stored, enabling the update manager 210 to also determine the portions of the forwarding table memory currently used (e.g., allocated) by current entries in the forwarding table 200. The forwarding table 200 may include various types of entries in different types of memory, including memories configured (and optimized) for lookup in the data plane by index value (e.g., the memory location), by key (e.g., a source MAC address and VLAN identifier), or value masking (e.g., with ternary content addressable memory). As such, the shadow table 230 may represent the prior state of the forwarding table 200, including entries along with allocated memory locations. This allows the update manager 210 to interact with the shadow table 230 as though it were checking the forwarding table 200 and to stage any modifications to be made to the forwarding table in the shadow table 230 that are subsequently written to the forwarding table 200.

The feature agents 220 manage entries for a control table 240 and generate table entries describing the post-modification or “desired” state of the entries in the forwarding table 200 after the modification. The feature agents 220 send these entries, termed “regenerated entries,” to the update manager 210 for consolidation and entry to the forwarding table 200. As discussed above, the feature agents 220 may determine various table entries specifying configurations for the forwarding table 200, such as local MAC addresses, IP address routing, nexthop packet rewrite information (e.g., an MAC address of a nexthop address), nexthop egress interface, VLAN membership, encapsulation parameters, packet labels, and so forth.

In some embodiments, the regenerated entries provided by the feature agent 220 describes table entries for the forwarding table 200 and the feature agent 220 receives a response as though the entry was entered to the forwarding table 200. For example, in normal operation (e.g., during operation of the feature agents when no modification has been applied and the update manager is not active), a table entry is sent by a feature agent 220 for entry in the forwarding table 200 and the forwarding table 200 may return a respective index at which the entry was recorded. When the update manager 210 receives a regenerated entry (after a modification), the update manager 210 may determine whether the shadow table 230 already has a corresponding entry and, if so, identify the index from the shadow copy (which matches the index of the forwarding copy) and return the index to the feature agent 220 as indicating the regenerated entry is recorded in the forwarding table 200 at that index. For example, packet processing parameters for a particular nexthop device (e.g., a nexthop destination MAC address) may be stored with respect to an index. The returned index, in some instances, may then be used by one of the feature agents 220 as a field or lookup result for another regenerated entry. For example, a routing table entry retrieved based on a destination IP address may include an index for relevant packet processing parameters as a result of the lookup. By providing the entry index in response to the regenerated entry request, the update manager 210 may provide relevant information for the feature agents 220 to construct relevant information about the state of the forwarding table 200 for the control table 240.

As the update manager 210 processes the regenerated entries, the update manager 210 attempts to match the regenerated entries with corresponding entries in the shadow table 230 and modify the shadow table 230 to reflect the intended changes to the forwarding table 200 accordingly. When a matching entry in the shadow table 230 has different contents, the contents may be changed in the shadow table 230. When no match is found in the shadow table 230, a new entry may be allocated in the shadow table 230. In one embodiment, packet processing by the data plane is selectively paused, such that the packet processing continues until the update manager 210 determines that one of the regenerated entries results in a change to the forwarding table 200. When none of the regenerated entries modify the shadow table 230, the regenerated entries may all be processed without stopping operation of the data plane.

To manage the shadow table 230 and identify modifications to be applied to the forwarding table 200, the update manager 210 may also track status (e.g., with a flag) of entries in the shadow table 230 as the regenerated entries are processed. For example, the status may designate that the entry has not been matched to any regenerated entries (the initial status when the shadow table is created), the entry matches a regenerated entry (and was not modified), the entry is modified by a matching regenerated entry, or that the entry is newly added (for regenerated entries that did not have a matching entry in the shadow table 230). The status may then be used to determine which entries in the shadow table 230 should be applied to modify the forwarding table 200.

In one embodiment, the modifications to the shadow table 230 are consolidated and applied to the forwarding table 200 after all regenerated entries are processed. As such, in some configurations, the packet processing is not paused until the consolidated modifications are ready to be applied to the forwarding table 200. In another configuration, the packet processing may be paused when any regenerated entry is identified as changing the shadow table 230, but the remaining regenerated entries may be processed (e.g., for the complete configuration of the feature agents) before consolidating changes to the shadow table 230 for consolidated updates to the forwarding table 200. In addition to applying modifications of the shadow table (e.g., modified entries or newly-added entries), in some cases, entries of the shadow table that were not matched to any regenerated entries are identified and the corresponding entries in the forwarding table are pruned. Because the set of regenerated entries may represent the complete set of entries intended to be stored in the forwarding table, entries in the prior state of the forwarding table (i.e., as stored in the shadow table) may represent entries that are no longer used or referenced after the modification, enabling the corresponding entries to be safely pruned.

As such, the update manager 210 in some embodiments may operate as an intermediary between the feature agents 220 and the forwarding table 200, such that pausing packet processing and applying modifications to the forwarding table 200 are mediated by the update manager 210.

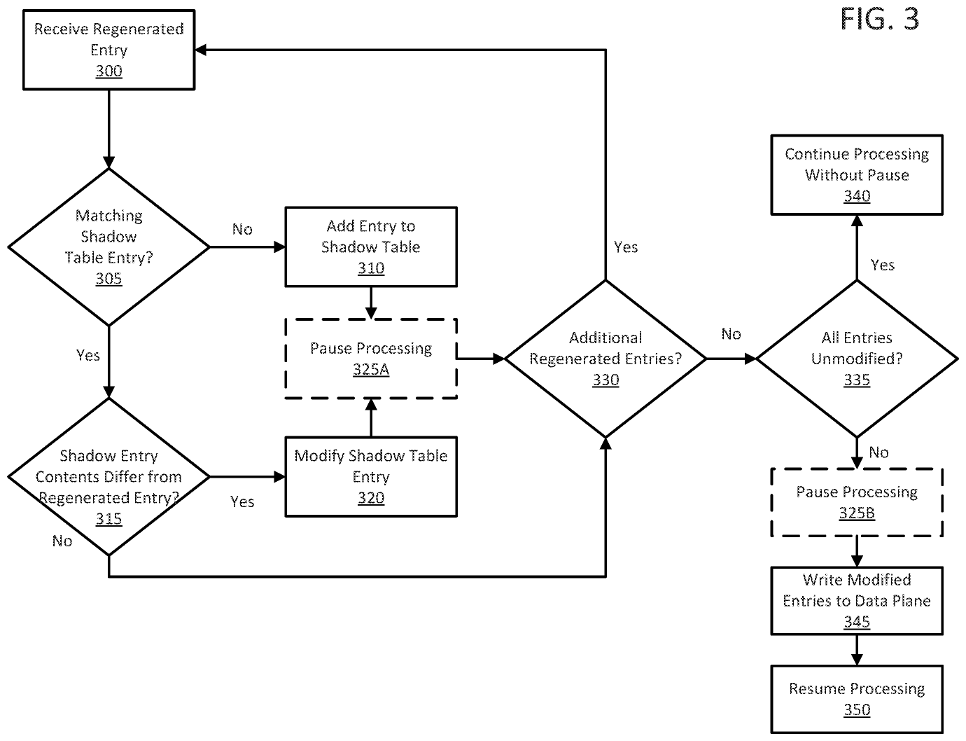

FIG. 3 is an example process for selectively updating a forwarding table after a modification to a networking controller, according to one embodiment. The process shown in FIG. 3 is performed, e.g., by a networking device and an update manager as discussed in FIGS. 1 and 2. The process may thus be performed by a processor executing a corresponding set of instructions, and in some embodiments may be at least partially implemented in one or more circuits, including programmable circuits or an application-specific integrated circuits (ASIC). In this example, a shadow table with a set of shadow entries is already copied from the forwarding table and may initially be indicated or marked as having “no match” with any regenerated entries. The example of FIG. 3 shows regenerated entries processed sequentially; in alternate configurations the regenerated entries may similarly be processed in parallel.

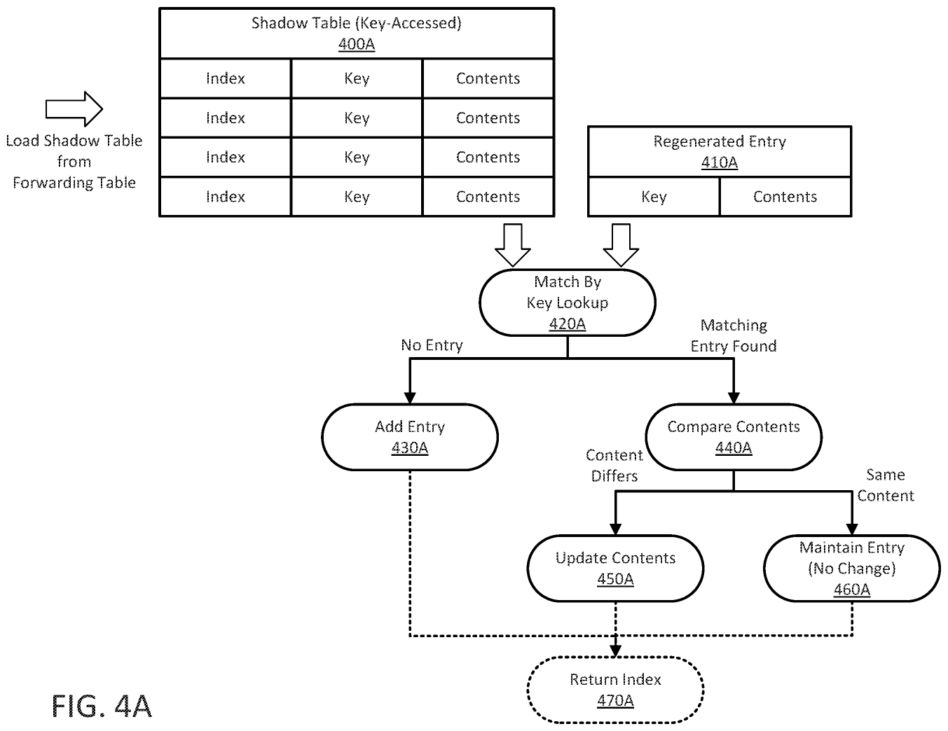

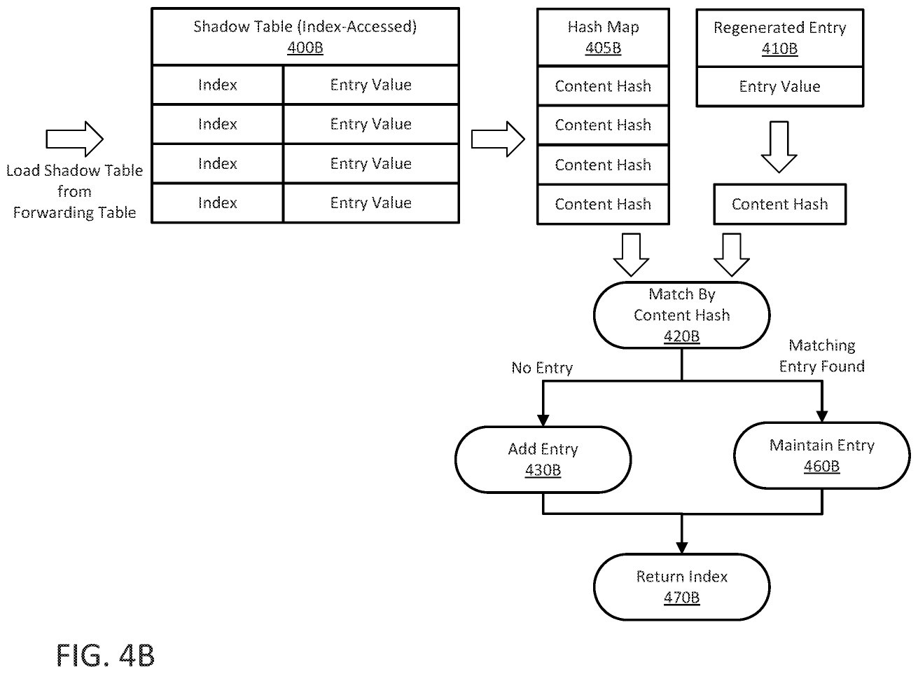

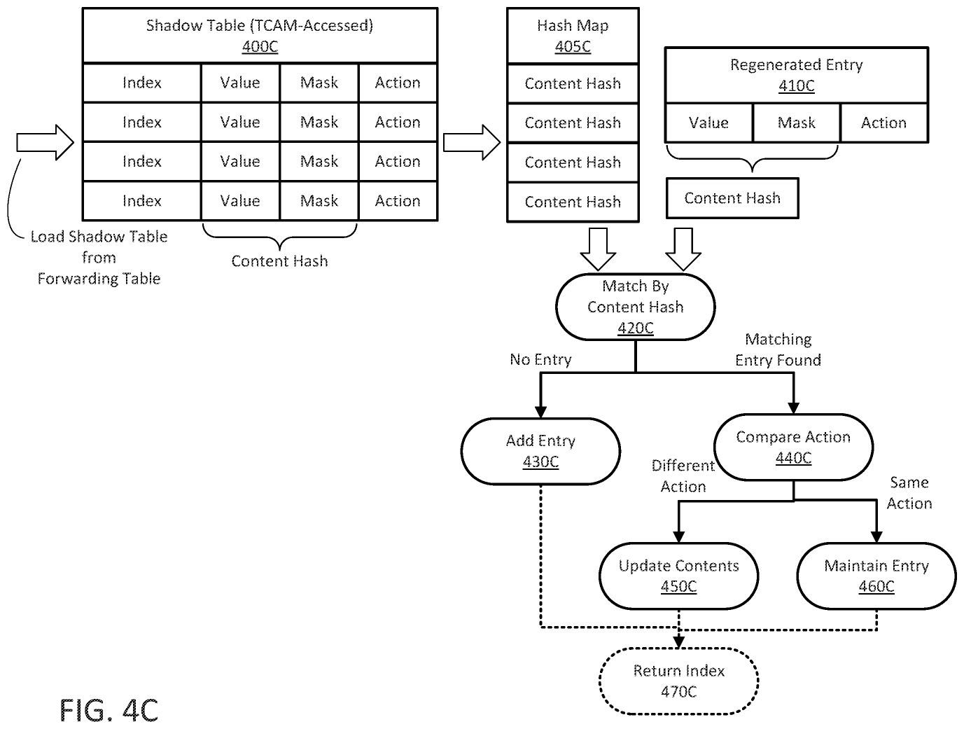

Regenerated entries are generated by the networking device, e.g., by a set of feature agents and received 300 for evaluation. Rather than directly apply the regenerated entry to the forwarding table, the process of FIG. 3 determines whether the regenerated entry represents a change to the forwarding table by comparing the regenerated entry to the shadow table. To determine whether the shadow table is changed, the regenerated entry is used to determine whether 305 there is a matching entry for the regenerated entry in the shadow table. A matching entry may be determined in various ways based on the type of data. The various types of data are discussed further below with respect to FIGS. 4A-C. When there is not a matching entry, an additional entry is allocated in the shadow table and the regenerated entry is added 310 to the shadow table. The added entry in the shadow table may be marked or otherwise indicated with a status that indicates it is a modification of the shadow table relative to the prior state of the forwarding table.

When there is a matching shadow table entry, the contents of the shadow table entry is compared to the content of the regenerated entry to determine whether 315 contents of the relevant entry are changed by the regenerated entry. When the contents differ, the contents of the shadow table entry is modified 320 to reflect the changed information of the regenerated entry. The modified shadow table entry may be marked or otherwise indicated with a status indicating that it is modified.

When the shadow table is modified, either by a new entry or a modified existing entry, the processing by the data plane may be paused 325A-B, either pausing processing 325A when an entry is determined to be incorrect in the current forwarding table (relative to the regenerated entry), or pausing processing 325B before applying modified entries to the forwarding table. As such, in some embodiments, the processing is paused 325A the first time a modification to the shadow table is identified and remains paused until the regenerated tables have all been processed. In other embodiments, the processing is not paused 325B until after evaluating all of the regenerated entries to identify the modified entries to apply. When a regenerated entry has a matching shadow table entry with contents that do not differ from the regenerated entry, the existing forwarding table already includes the desired information and thus no change to the shadow table is made or pause to packet processing is needed due to the regenerated entry. In some embodiments, the entry of the shadow table may have a status updated to indicate that the shadow table entry has a corresponding regenerated entry (to distinguish from shadow table entries that do not correspond to any regenerated entries and may later be pruned).

After evaluating one regenerated entry, the process evaluates whether 330 there are additional regenerated entries and if so, proceeds to process another regenerated entry. When all regenerated entries have been processed (e.g., evaluated with respect to the shadow table), the process determines 335 whether all entries of the shadow table are unmodified. When the shadow table is not modified by the regenerated entries, the data plane may continue 340 to process packets without a pause due to the controller update. When the shadow table is modified (a new entry or a modification of an existing entry), the data plane processing may be paused 325B (if not yet paused), modified entries are written 345 to the data plane and the packet processing is resumed 350 with the updated data. In some embodiments, the modified entries in the shadow table may modify a limited group of tables or entries in the forwarding plane, such that in some embodiments the processing is paused only for affected tables/entries and may be continued for the unaffected tables/entries.

### Shadow Table Management

FIGS. 4A-C show example processing of regenerated entries with respect to a shadow table, according to various embodiments. FIGS. 4A-C show different types of entries that may be in the forwarding table and copied to respective shadow tables 400A-C.

The shadow table 400A of FIG. 4A shows entries that may be accessed at the data plane based on a key. For example, the shadow table 400A may store exact-match destination address (e.g., an IP address) routing information, such that a specific destination address in a packet header is provided as a key for lookup of the relevant nexthop information as the contents of the entry. The regenerated entry 410A for this type of entry similarly specifies a key (used for lookup of the entry at the data plane) and related contents. Each entry in the shadow table 400A may also have a corresponding index that may represent the memory position or other physical location of the entry in the forwarding table.

To process the key-accessed entries, a key lookup 420A is performed for the key of the regenerated entry 410A with respect to the keys of the shadow table 400A. When the shadow table does not have an entry matching the regenerated entry 410A (i.e., the key lookup is a miss), the regenerated entry 410A is added 430A to the shadow table 400A. When the key lookup results in a matching entry, the contents are compared 440A to determine whether the contents of the regenerated entry 410A differ from the matching shadow entry. When the contents differ, the contents are updated 450A and when the contents are the same, the existing shadow table entry is maintained 460A without a change. As discussed above, when an entry is added 430A or updated 450A, the entry in the shadow table may be marked to indicate the modified status (and that the entry should thus be written to the data plane). When the entry is matched 420A and maintained 460A, the entry may similarly be designated as having a matching regenerated entry such that the entry is not pruned. Finally, the index of the matching entry (or the newly-added entry) may be returned 470A to the requesting feature agent or another part of the networking controller. The index value returned for the shadow table 400A is the same as the index in the forwarding table for the entry, such that the returned index may be used for further management of the forwarding table after the update manager completes processing of the regenerated entries.

The example shadow table 400B shown in FIG. 4B shows table entries that are accessed by index (e.g., referenced by the memory location of the entry). For these entries, the corresponding entry in a shadow table may not be directly accessed with information of the regenerated entry 410B. That is, in use the entry in the forwarding table may be accessed with the index, such as with a reference or pointer, such that the regenerated entry itself (e.g., the contents of the regenerated entry 410B) does not yet have a respective index with respect to the forwarding table.

For shadow table 400B, the relevant entry is thus identified based on the content (e.g., the entry value) of the respective index. To enable effective lookup of the entry, entries in the shadow table 400B are processed to determine a respective content hash and generate a hash map 405B for the entries. The hash map 405B organizes the entries according to the content hash for effective searching based on the content hash. A hash function is applied to the entry value of an entry to generate the content hash. The hash function is used to characterize the entry value and enable more effective lookup based on the content hash in the hash map 405B, which organizes and enables lookup by the content hash (e.g., so that the content hash may be used as a “key” for looking up a relevant entry). The entry value of the regenerated entry 410B is similarly processed by the hash function to generate a content hash of the regenerated entry 410B. The hash function is deterministic, such that the same entry value results in the same output content hash. The regenerated entry is matched 420B to a shadow table entry based on a match of the content hash.

When there is no matching shadow table entry, the regenerated entry 410B is added 430B, and when there is a matching shadow table entry, the entry is maintained 460B (e.g., marked as present in the regenerated entries) as discussed above. The index of the matching or added entry is returned 470B, such that the index can be used by the requesting feature agent or stored in the control table. The index may be used, for example, as a data field in other regenerated entries that point to entries in the index-accessed entry.

FIG. 4C shows a shadow table 400C with entries accessed in ternary content addressable memory (TCAM). TCAM entries enable lookup of entries by a value and a mask that specifies portions of the value that can be any value for a match. For example, a group of IP addresses defined by 43.75.107.* (denoting a range of all IP addresses beginning with 32.75.107) may be defined in a TCAM entry with a value 43.75.107.0 and a mask of 0.0.0.* to designate that the lookup must match the first three values (43, 75, and 107) and the final value may be satisfied in the lookup with any value. The content value or data associated with the corresponding entry is termed an “action” or a “result.” As one way of accessing the relevant entry, a hash map is constructed similar to the index-based entries shown in FIG. 4B, but rather than a content hash of the contents, the hash map 405C is generated with a content hash based on the value and mask, enabling different value-mask combinations to be distinguished.

A content hash is similarly generated with the value and mask of the regenerated entry 410C and used to match 420C the regenerated entry with the shadow table based on the content hash. When there is no match, the regenerated entry 410C is added 430C to the shadow table. As the relevant entries are also associated with additional contents (the action), in addition to identifying the matching entry, the actions (as the entry “content”) is compared 440C to determine whether the matching entry designates a different action than the regenerated entry 410C. When it does, the entry contents (the action) is updated 450C, and when the actions are the same, the entry is maintained 460C. The added, updated, or maintained shadow entry may then be marked as discussed above and an index to the corresponding index is returned 470C.

By identifying the respective entries in the shadow table and maintaining them (or modifying the entry itself), use of the forwarding table as-is from before the modification to the networking controller is optimized and enables, in many cases, continued operation of the data plane without any pause to packet processing attributable to the controller modification and re-generation of tables by the control plane after the modification.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A networking device comprising:
a set of interfaces for sending and receiving packets;
a packet processor that processes packets received at the set of interfaces according to a set of entries of a forwarding table; and
a networking controller that configures operation of the packet processor and, after applying a modification to operation of the networking controller, is configured to:
identify a set of regenerated entries describing post-modification configuration of the forwarding table after the control configuration modification;
copy the set of entries of the forwarding table to a set of shadow entries of a shadow table describing operation of the forwarding table before the modification was applied; and
compare the set of regenerated entries to the set of shadow entries and, based on the comparison, selectively pause packet processing by the packet processor when at least one of the set of regenerated entries differs from the shadow entries.

2. The networking device of claim 1, wherein comparing the set of regenerated entries to the set of shadow entries comprises determining a matching shadow entry for at least one regenerated entry based on a content hash of the shadow entry and the regenerated entry.

3. The networking device of claim 1, wherein the networking controller is further configured to pause processing immediately when any difference is identified between the set of regenerated entries and the set of shadow entries.

4. The networking device of claim 3, wherein the networking controller is further configured to consolidate differences between the regenerated entries and the shadow entries in the shadow table and apply the consolidated differences to the forwarding table after all of the set of regenerated entries are compared with the set of shadow entries.

5. The networking device of claim 1, wherein the networking controller is further configured to selectively pause processing by the packet processor for a first entry of the forwarding table corresponding to a first shadow entry that has different contents relative to a first matching regenerated entry and continuing processing by the packet processor for a second entry of the forwarding table corresponding to a second shadow entry that has the same contents relative to a second matching regenerated entry.

6. The networking device of claim 1, wherein one or more feature agents construct a control table and the set of regenerated entries is generated based on the control table.

7. The networking device of claim 1, wherein the networking controller is further configured to:
determine a set of unused entries in the shadow table that do not correspond to any of the regenerated entries; and
prune entries in the forwarding table that correspond to the set of unused entries.

8. The networking device of claim 1, wherein the modification to the networking controller is a modified software version.

9. A non-transitory computer-readable medium comprising instructions executable by a processor for:
applying a modification to a networking controller of a networking device that includes a packet processor that processes packets according to a forwarding table during application of the modification to the networking controller;
copying the forwarding table to a shadow table; and
after the modification is applied to the networking controller:
identifying one or more regenerated entries generated by the networking controller after the modification is applied, wherein the one or more regenerated entries specify post-modification entries of the forwarding table;
for each of the one or more regenerated entries, determining whether the shadow table includes a matching entry and whether the matching entry and the regenerated entry have the same contents;
determining whether all of the one or more regenerated entries have a matching entry with the same contents; and
responsive to determining that all of the one or more regenerated entries have a respective matching entry with the same contents, continuing to process packets after the modification of the networking controller without pausing packet processing for application of the one or more regenerated entries.

10. The non-transitory computer-readable medium of claim 9, wherein the instructions are further executable for selectively pausing the packet processor responsive to determining that any of the regenerated entries does not have a matching entry or the matching entry and the regenerated entry do not have the same contents.

11. The non-transitory computer-readable medium of claim 10, wherein the instructions are executable for continuing the packet processor while the modification is applied until the packet processor is selectively paused.

12. The non-transitory computer-readable medium of claim 9, wherein determining a matching entry in the shadow table is based on comparison of a content hash of the shadow table with the regenerated entry.

13. The non-transitory computer-readable medium of claim 9, wherein the instructions are further executable for:
modifying the matching entry in the shadow table when its contents differ from the regenerated entry; and
applying the modified entries in the shadow table to the forwarding table together as a group.

14. The non-transitory computer-readable medium of claim 9, wherein the instructions are further executable for adding an entry to the shadow table when a regenerated entry does not have a matching entry in the shadow table.

15. The non-transitory computer-readable medium of claim 9, wherein the instructions are further executable for:
determining a set of unused entries in the shadow table that do not correspond to any of the regenerated entries; and
pruning entries in the forwarding table that correspond to the set of unused entries.

16. A method, performed by a networking device that processes packets according to a forwarding table, for reducing packet processing interruption due to modification of a networking controller of the networking device, comprising:
applying a modification to a networking controller of a networking device that includes a packet processor that processes packets according to a forwarding table during application of the modification to the networking controller;
copying the forwarding table to a shadow table; and
after the modification is applied to the networking controller:
identifying one or more regenerated entries generated by the networking controller after the modification is applied, wherein the one or more regenerated entries specify post-modification entries of the forwarding table;
for each of the one or more regenerated entries, determining whether the shadow table includes a matching entry and whether the matching entry and the regenerated entry have the same contents;
determining whether all of the one or more regenerated entries have a matching entry with the same contents; and
responsive to determining that all of the one or more regenerated entries have a respective matching entry with the same contents, continuing to process packets after the modification of the networking controller without pausing packet processing for application of the one or more regenerated entries.

17. The method of claim 16, further comprising selectively pausing the packet processor responsive to determining that any of the regenerated entries does not have a matching entry or the matching entry and the regenerated entry do not have the same contents.

18. The method of claim 17, further comprising continuing the packet processor while the modification is applied until the packet processor is selectively paused.

19. The method of claim 16, wherein determining a matching entry in the shadow table is based on comparison of a content hash of the shadow table with the regenerated entry.

20. The method of claim 16, further comprising:
modifying the matching entry in the shadow table when its contents differ from the regenerated entry; and
applying the modified entries in the shadow table to the forwarding table together as a group.
